(19) United States
(12) Patent Application Publication
(10) Pub. No.: US 2016/0096741 A1
(43) Pub. Date: Apr. 7, 2016

(54) DATA COLLECTION SYSTEMS AND METHODS FOR WATER/FLUIDS

(71) Applicant: Huei Meng CHANG, Milpitas, CA (US)

(72) Inventors: Yee Chun LEE, Millbrae, CA (US); Huei Meng CHANG, Milpitas, CA (US); Narayan D RAJU, Fremont, CA (US)

(21) Appl. No.: 14/841,697

(22) Filed: Aug. 31, 2015

Related U.S. Application Data
(63) Continuation-in-part of application No. 13/733,842, filed on Jan. 3, 2013.
(60) Provisional application No. 62/044,192, filed on Aug. 30, 2014.

(51) Int. Cl. C02F 1/00; G05B 13/04; H04W 4/00; H04L 29/08; H04L 12/46; H04L 29/06; C02F 1/04

(52) U.S. Cl. CPC C02F 1/008; H04L 63/0272; G05B 13/048; C02F 1/04; H04L 67/10; H04L 12/4633; H04W 4/008; C02F 2209/008

(57) ABSTRACT

A system and method for controlling a fluid or specifically water treatment system having a plurality of multiple module treatment sites utilizing both low latency local control and higher latency global operational control is provided. Said multiple module treatment site comprises one or more multitude Pulse Effect Distillation™ (PED) modules, one or more pretreatment units, and one or more sludge concentration and storage units. Said control system and method examines sensor signals corresponding to selected PED parameters of the same PED module and takes actions based on measured and estimated PED parameters. The actions taken might comprise one or more of the following; opening or closing the flow control valves for input water, produced water, and brine, activating compressor RPM and torque control, turning on/off the starting/stabilizing heaters, processing and selectively forwarding processed signals and actions, and receiving control signals from the site control panel to readjust reference/set point parameters of said embedded PED controller or to perform such actions as PED backwash, and PED shutdown, restarting, and cartridge replacement.

### CROSS-REFERENCE TO RELATED APPLICATIONS

This application claims priority as a Continuation-in-Part to pending U.S. patent application Ser. No. 13/733,842 “Method and Apparatus for Water Purification”, filed on Jan. 3, 2013, and also claims priority to U.S. Provisional Patent Application 62/044,192 “Data Collection Systems and Methods for Water/Fluids”, filed Aug. 30, 2014, the disclosure of both aforementioned applications is incorporated herein by reference in their entirery.

### FIELD OF THE INVENTION

PED (Pulse Effect Distillation™), per the US Patent Application Publication, US 2013/0175155, is a thermal distillation technology based on a counter-flow 2-phase to 2-phase heat exchange process with evaporation cavities and condensation cavities on opposite sides of the common heat exchange walls.

The local operational control comprises a site control panel, a data communications means, and a microprocessor based embedded controller for each of said PED module. Said embedded controller examines sensor signals corresponding to selected PED parameters of the same PED module and takes actions based on measured and estimated PED parameters. The actions taken might, for example, comprise opening or closing the flow control valves for input water, produced water, and brine, activating compressor RPM and torque control, turning on/off the starting/stabilizing heaters, processing and selectively forwarding processed signals and actions taken to said site control panel, and receiving control signals from the site control panel to readjust reference/set point parameters of said embedded PED controller or to perform such actions as PED backwash, and PED shutdown, restarting, and cartridge replacement. The site control panel receives periodic updates about input, brine, and product flow rates, among others, from an individual PED module, and compares them to site average and historical data to determine the health and productivity of each individual PED module, as well as site operator inputs and takes actions accordingly. The site control panel also selectively forward processed site data to the global operational control center and receives specific instructions from it. The global operational control center processes individual site data and presents the processed data in a graphic user interface to permit transparent and comprehensive monitoring and control of the water treatment processes across all sites to enable automatic and human assisted operational control of said water treatment system for the purpose of optimizing operational and energy efficiencies, resource management, and reduction of maintenance requirements.

The invention relates to control and management of water treatment system and, more particularly, to advanced operational control system and methods for the optimal management of multisite water treatment and purification utilizing a plurality of modular PED units for each site.

### DESCRIPTION OF THE RELATED ART

Water treatment is a large scale process which turns highly contaminated source water which often has high total dissolved solid (TDS) and/or heavy metal concentration into product water which are acceptable for industrial, agricultural and household uses. In order to produce water suitable for drinking or for medical usages, the water needs to be purified to reduce or remove much of undesirable chemicals, biological and radioactive contaminants, suspended solids as well as foul smelling dissolved volatile organic chemicals (VOC) to the extent that the final product water is suitable for human consumption and for other uses which require water of extreme high purity.

PED (Pulse Effect Distillation™), per the US Patent Application Publication, US 2013/0175155, is a thermal distillation technology based on a counter-flow 2-phase to 2-phase heat exchange process with evaporation cavities and condensation cavities on opposite sides of the common heat exchange walls. The primary energy input for the PED process is mechanical gas compression. Although such a heat exchange maintains a temperature gradient which is an intrinsic characteristic of a counter-flow heat exchanger, the specific PED distillation process mimic an ideal thermodynamically reversible process and indeed approaches that ideal limit when cross-wall and flow-oriented thermal resistances are zero and infinity, respectively. As such, the energy efficiency of PED based water purification process depends entirely on how close the PED process can imitate the ideal thermodynamic reversible process, which in turn depends on the minimization of the specific rate of increase in the entropy flows between the input fluid (which may be in one embodiment source water) and the output fluids (product water and brine). The sources of such entropy rate increases are primarily the direct heat input (which introduces entropy inflow; note that mechanical energy input introduces no increase in entropy inflow!) and internal entropy production rates. Internal entropy production mainly comes from cross wall and parallel thermal transfers as well as from viscous and turbulent resistances to fluid flows for both water and gases (air and water vapor). For inadequately insulated PED enclosures, the inevitable heat dissipation to the external environment also introduces additional entropy production with attendant loss of energy efficiency.

Although PED is primarily designed to produce distilled water free of virtually all contaminants except VOCs, it would be possible to modify PED to produce lower purity product water by replacing the solid common heat exchange wall substrate with gas permeable hydrophobic micro-pore polymeric membrane which permits the direct exchange of the air-vapor mixture through pressure differential driven diffusion from the higher pressure condensation cavities to the lower pressure evaporation cavities. The direct gas exchange introduces additional heat flux which easily exceeds the indirect heat exchange flux through heat conduction and local heat convection, thereby greatly increases both the water production rate and the energy efficiency as it reduces the heat exchange induced entropy production rate. Despite its similarity to membrane distillation technologies which likewise employ hydrophobic gas permeable polymeric membrane, the modified PED process is entirely different in that it is still based on a well-defined thermodynamic reversible process with mechanical gas compression, hence it is intrinsically more energy efficient. These enhancements come at the price of lower product water quality precisely because of the pressure induced gas diffusion through the porous heat exchange walls which also permits the diffusion of dissolved solids and other micro-contaminants across the heat exchange walls, unlike traditional membrane distillations where the gas pressure is typically slightly higher on the evaporator side than on the condenser side wherewith the gaseous flux actually travels in exactly the opposite direction from what is described here for the modified PED process.

By alternating the compression and expansion cycles (pulse effect; note that a compressor actually does both compression and expansion), the air (gas) within evaporation cavities alternatively becomes saturated and under-saturated. During the under-saturated phase, a portion of the dissolved solids, especially those with calcium and heavy metal based compounds precipitates onto the membrane surface as the input fluid exceeds the solubility limits for those compounds. Once the solids are precipitated onto the porous membrane surface, it would be difficult for them to be dissolved back into the input fluid owing to the large concentration of the dissolved solids in the immediate vicinity of the deposited solids. While such precipitation further enhances the distillation efficiency, it also permits rapid accumulation of precipitated deposits which must be periodically back-flushed to rid of such deposits. The back-wash process entails the shutting off of the input water valve, shunting of the back-flushed water to the brine outlet, and the concomitant opening of the brine valve to allow the back-flushed fluid to flow into the brine storage for further sludge treatments. The brine valve should also be activated periodically to ensure that the brine concentration within the evaporator cavities does not exceed the preset limits.

The alternating compression/expansion, or “Pulse Effect” compression/expansion approach would be particularly beneficial for source waters such like fracking water which contains high concentration of heavy metal salts as well as calcium oxide or calcium bicarbonate, which are known to be weakly soluble and may have negative temperature dependencies in their solubility. As such, the pulse effect method would cause such dissolved compounds to precipitate readily onto the evaporator side of the semi-permeable membrane, wherewith the heavy metal solids can be collected through back washing the evaporation cavities separately from regular salts (sodium chlorides). In fact, it would be possible to take advantage of the differences in solubility to further separate them apart by timing the back wash, mist generation, and expansion cycles differentially to preferentially precipitate and collect heavy metals of different solubility. The ability to separately concentrate heavy metals from regular salts would allow pulse effect treated water to be rid of almost all heavy metal content. And since heavy metal compounds and far more toxic than most other salts, and the fracking water which were dredged from deep down into earth's mantle, such water also contains far higher radioactive elements such as radium, and its radioactive byproduct such as radon gas, the ability to remove them from the input water stream early on is a big plus. Since the main purpose of treating fracking water is to remove heavy metal contents and radioactive element, unlike seawater (of typical TDS around 35,000 ppm), membrane of relatively large pore sizes would suffice as the modified PED would still be able to remove most of biologics and fine sediments/colloids.

To reduce energy and maintenance requirements for a single PED based water treatment module, a detailed wet-bulb/dry-bulb temperature, pressure, flow rate, and TDS concentration distributions for the PED should be reconstructed through the deployment of multiple related sensors throughout the PED module. The reconstructed distributions can be used to perform entropy production analysis, and the results of the entropy analysis can be utilized to determine specific actions that need to be taken in real time in order to evolve the PED toward more optimal thermodynamic process. The PED predicative analysis can also be employed to determine if said PED module is in a fault state that needs to be restarted, back-washed, or be taken offline by comparing the predicted PED state with site-wise and historical state data. Some of the possible actions to be taken are opening and closing of input and product water valves, input shunt valve, brine shunt valve and brine output valve, compressor RPM, torque value, switching on/off of the starter/stabilizer heating coils, back wash water pump switching, etc. It is also possible to determine if a leakage had occurred by balancing the average or aggregated inflow and outflow rates and brine effluent flow rate. The PED will be taken offline if a leakage is suspected and a human operator is alerted. The ratio of the inflow rate and the average brine flow rate is also critical to the energy and operational efficiencies of the module since a high ratio implies a high brine concentration on the evaporator side which would adversely affect the energy efficiency of the treatment process, as well as causing the module to aggregate precipitates and TDS at an accelerated rate which would require more frequent back washing and other maintenance chores and likely will shorten the useful service life of the module. However, too frequent flushing of concentrated brine would reduce the water recovery ratio, which would drastically increase the pretreatment needs as well as the cost of sludge handling and disposal. The data communications between the site control panel and the individual PED modules can be based on secure wired or wireless connections. If wireless communications is chosen, both link to link and end to end encrypted virtual tunnels are employed in encapsulation to ensure security of data transport to prevent hacking.

The control strategy means for the management of a multiple-module site where said site has PED modules distributed throughout the site area would be slightly different from that of the control means for a single PED module. A single PED control strategy that only responds to local PED specific conditions and is actuated by the MCU (microcontroller unit) based on the data processed from the signals coming from the multi-channel sensors embedded within said PED module does not take into account of the rises and falls of the source water supply and product water demand throughout the day. Since the energy efficiency of the PED depends critically on the logarithmic mean temperature difference (LMTD) across the heat exchange walls as the aggregated internal entropy production rate for the cross wall heat exchange is proportional to the square of the LMTD, and since the water production rate is almost directly proportional to the same LMTD, there is a need to distribute the inflow of the source water as evenly as possible amongst all site PED modules so as to keep the site LMTD as low as possible. However, due to the uneven performance characteristics of the PED modules, the historical performance index for each PED module should also be taken into account in the site optimization process.

This means that a lower LMTD budget should be allocated to a poorer performing PED module than that of an excellent performing module, and a PED module that has been under steady high LMTD load should have reduced LMTD load or to be taken offline altogether to provide a rest period for the heavily used PED module during off-peak hours. More frequent back washing should also be employed to those heavily loaded modules to ensure that no significant precipitate accumulation can occur to avoid scaling and other fouling conditions which would lessen the useful lives of such modules. Last but not least, the inflow and outflow rates of the individual module should be relatively constant instead of having highly irregular flow rates in order to attain high energy and operational efficiencies. Since the aggregated input and product water storage capacities of the site PED modules can be quite considerable, the same modules can also be used as temperate storage buffers by adjusting the inflow and outflow rates ahead of and in anticipation of the upcoming increase in water demand. The pretreated water is stored within each module to partially offset the future increase in water demand.

For an industrial scale water treatment system involving multiple treatment sites distributed over a large service area, control strategies that pertain to a single PED or the aggregated PED modules of a single site are no longer adequate. Although localized distribution of LMTD loads is still possible amongst adjacent water treatment sites as long as pipe and pumping station network is adequate to properly distribute the source, product, and brine water among nearby nodes (sites). Absent any wide area redistribution of source and/or product water, a global control strategy must involve a cost matrix that includes the local source supply, water demand, and water redistribution costs, and overall responsiveness and maintenance requirements, as well as the expected service lives and replacement costs of the individual equipment. A mathematical optimization algorithm such as linear programming, dynamic programming, or Newton-like nonlinear optimization technique can be employed to determine a set of actions to be applied to each treatment site to optimize overall system and operational efficiencies. The data communications between individual sites and the operation control center may employ wired or wireless data access through either a private cloud or a public web-based cloud. Or it may even be a hybrid cloud based system with secure data transported only within an encrypted private cloud with restricted accessibility only via a virtual private network (VPN) and non-secure information accessible through a less secure two factor log-on authentication.

The existing water treatment systems often operate under conditions which are sub-optimal, causing increased energy usage and high maintenance costs and manpower needs. Further, the water treatment control strategy often could not keep up with varying water supplies and demands in on and off peak hours and from location to location.

A prior art focusing on the control strategy of a single waste water treatment site involving a plurality of pump stations along a multitude of force mains is provided by U.S. Pat. No. 8,594,851 B1 to Thomas F. Smaidris (US), Nov. 26, 2013. Smaidris taught that each wet well is equipped with a multitude of well sensors, with well water level sensor being the most prominent one, and a ladder logic and programmable logic controller (PLC) employed to process the sensor signals. The resulting data is forwarded to a telemetry control unit which then forwards the telemetry data to a radio unit to broadcast it to a central control location. Each well is served by a pump station comprising a plurality of water pumps feeding from the well to a force main. A multitude of force mains converge and feed a waste water treatment plant wherein within each force mains, the connected pump stations are ordered in priority based on storage capacity of wet well and intake volume and communicate such information to the central, which in turn authorizes activation of pumps at pump stations based on such priority order. The central also performs flow management by identifying peak and slack periods for a given force main and ordering pump stations on said force main by distance from the treatment plant, and orders pump down wet wells in order from farthest to nearest. Smaidris also went at length on a detailed description of how a plurality of pump stations can communicate with a central server in a water management system incorporating an XGMI cognitive radio and a DFS hyper SCADA server. However, it is immediately clear that the specific radio technology used is largely immaterial as it can be replaced adequately by other more mature radio technologies such as Zigbee or WiFi at short ranges and cellular radios at long ranges without impacting in their functionality. And as far as the said control strategy is concerned, the proposed priority based pump management relative to a single main is entirely heuristic and does not distribute the pumping load in a mathematically optimal fashion. The proposed distance based flow management is equally heuristic in nature and does not optimally distribute the wet well loads in a mathematically sound fashion. Further, it treats each force main in a fashion which is completely independent of the other force mains, and owing to the inter-related nature of the force mains feeding the same water treatment plant, such a strategy is unlikely to be optimal.

U.S. Pat. No. 8,321,039 B2, to Graves (US), Nov. 27, 2012 describes an apparatus for managing a residential waste water treatment system that includes a local control unit that monitors an individual system to provide local control and alarm functions, as well as to transmit status reports and alarms to remote monitoring center via a web-based telemetry device. The remote monitoring center further makes information concerning the individual system available through a website. Graves went to a great length to teach a specific microprocessor based control input and alarm circuit whose sole purpose is to read the analog input from the time clock knob to set and control the aerator motor in accordance with the time set by the knob. Although such a disclosure is important with respect to Graves intention of providing a cheap and reliable user interface panel of a control center to be installed in or in the vicinity of a residence or other buildings for monitoring a residential septic tank system, such a design does not provide any automatic and optimal control and management functions. And even though a central web based server is used, its main purpose is to provide service reports and alarms to subscribers of their service and to administer user access, invoice statement, and activation or suspension of user accounts or contracts.

Neither of the prior arts can be construed as a comprehensive optimal control system and method for managing an industrial scale water treatment and/or purification system. Smaidris's teaching is restricted in nature to the specific example of a pumping network for feeding wet well source water into a waste water treatment plant, and the proposed control strategy for well pumping is ad hoc and heuristic in nature with no pretense to any mathematical optimality. Graves' teaching is even more restrictive with no automatic control strategy to speak of. The main commonality between their teaching and the present invention is the potential use of radio data communications and web-based dissemination of processed information. Neither of these aspects is central to the teaching of the present invention.

The system/process for collecting and gathering data described in this patent application/document can also be used to gather the same or similar data from any other liquid/fluid purification or filtering system, not just a PED system.

### BRIEF SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

It is an object of the present invention to provide a system and method for controlling an industrial scale water treatment system that overcome the above-described limitations of prior art water management system.

It is a further object of the present invention to provide a method of mathematically optimal automatic control of an individual PED module.

It is another object of the present invention to provide a method of mathematically optimal automatic control of a single water treatment site comprising a plurality of PED modules.

It is still another object of the present invention to provide a method of mathematically optimal global control of an industrial scale water management system comprising a multitude of water treatment sites.

It is a still further object of the present invention to provide a system wherein status and control data can be transported through various data communications means.

These aforementioned objectives are accomplished in accordance with specific preferred embodiment of the present invention, by providing a water treatment system having a plurality of multiple module treatment sites utilizing both low latency local control and higher latency global operational control is provided. Said multiple module treatment site comprises a multitude of PED modules, one or more pretreatment units, and one or more sludge concentration and storage units. The local operational control comprises a site control panel, a data communications means, and a microprocessor based embedded controller for each of said PED module. Said embedded controller examines sensor signals corresponding to selected PED parameters of the same PED module and takes actions based on measured and estimated PED parameters. The actions taken might comprise opening or closing the flow control valves for input water, produced water, and brine, activating compressor RPM and torque control, turning on/off the starting/stabilizing heaters, processing and selectively forwarding processed signals and actions taken to said site control panel, and receiving control signals from the site control panel to readjust reference/set point parameters of said embedded PED controller or to perform such actions as PED backwash, and PED shutdown, restarting, and cartridge replacement.

The site control panel receives periodic updates about input, brine, and product flow rates, among others, from individual PED module, and compares them to site average and historical data to determine the health and productivity of each individual PED module, as well as site operator inputs and takes actions accordingly. The site control panel also selectively forward processed site data to the global operational control center and receives specific instructions from it. The global operational control center processes individual site data and presents the processed data in a graphic user interface to permit transparent and comprehensive monitoring and control of the water treatment processes across all sites to enable automatic and human assisted operational control of said water treatment system for the purpose of optimizing operational and energy efficiencies, resource management, and reduction of maintenance requirements.

The system/process for collecting and gathering data described in this patent application/document can also be used to gather the same or similar data from any other liquid/fluid purification or filtering system, not just a PED system.

In one aspect, the invention is about a fluid treatment system comprising a plurality of fluid treatment processing modules located within a site, wherein each said processing module is comprised of at least one from the list of; sensors and/or transducers, electronic control means and/or data communications means, wherein each said module may receive sensor signals from each said sensor so as to have said module's electronic control means form and/or execute a model predictive decision process wherewith to determine action to be taken through one or more of each said transducers for the purpose of maximizing operational efficiency within each said module and when necessary use, and said data communications means transmits processed module status data to one or more site control panels, one or more site control panels overseeing one or more processing modules within a site, wherein each said site control panel is in communication with one or more said fluid treatment modules in order to communicate status information to/from one or more said modules, collect, process, analyze and/or update information about said one or more panels, communicate to/from one or more operational control center(s) and update individual processing module(s) reference parameters through said communication means, one or more operational control center(s) in communications with said one or more site control panels in order to communicate site specific reference parameters and/or status updates to/from said one or more site control panels, wherein said one or more operation control center(s) utilize site control strategy means to analyze, generate and periodically update individual processing module specific parameters based on site parameters that are common to a plurality of processing modules, so that based on desired optimal individual module response, individual parameters for one or more said process modules control are distributed to each said module via one or more of said control panels.

In another aspect, said site control strategy means include site/individual module data/status attributes comprised of at least one of: site fluid demands, site safety parameters, site source fluid status, site logarithmic mean temperature difference, module flow rates, module status, module schedule maintenance and/or module deviation from normal parameters; and said data communications means may be comprised of at least one of; wired or wireless links, encrypted radio links, secured private network connection, Wi-Fi (including but not limited to IEEE802.11n, 802.11ac and similar variations), ZigBee, Bluetooth, Cellular radio (including but not limited to 3G, 4G, LTE and similar variations). In yet another aspect, selected process information from one or more said process modules from one or more sites is presented through a user interface to a human so that they may be adjusted through human assisted actions. In another aspect, said information presented to said human is comprised of at least one of: general account information, site-wide operation status, maintenance records, alarm history, service contract status, financial balance sheets, and/or regulatory compliance records.

In one aspect, said fluid control modules are Pulse Effect Distillation™ (PED) modules. In another aspect, said one or more operational control center(s) and said one or more site control panel(s) are located in a private secure cloud. In yet another aspect, said one or more operational control center(s) and said one or more site control panel(s) are located in a virtual private network tunnel to a web based cloud.

In one aspect, the invention is about a fluid treatment method embodying some of the above aspect and specifically comprising providing a plurality of fluid treatment processing modules located within a site, wherein each said processing module is comprised of at least one from the list of; sensors and/or transducers, electronic control means and/or data communications means, wherein each said module may receive sensor signals from each said sensor so as to have said module's electronic control means form and/or execute a model predictive decision process wherewith to determine action to be taken through one or more of each said transducers for the purpose of maximizing operational efficiency within each said module and when necessary use, and said data communications means transmits processed module status data to one or more site control panels, providing one or more site control panels overseeing one or more processing modules within a site, wherein each said site control panel is in communication with one or more said fluid treatment modules in order to communicate status information to/from one or more said modules, collect, process, analyze and/or update information about said one or more panels, communicate to/from one or more operational control center(s) and update individual processing module(s) reference parameters through said communication means, providing one or more operational control center(s) in communications with said one or more site control panels in order to communicate site specific reference parameters and/or status updates to/from said one or more site control panels, wherein said one or more operation control center(s) utilize site control strategy means to analyze, generate and periodically update individual processing module specific parameters based on site parameters that are common to a plurality of processing modules, so that based on desired optimal individual module response, individual parameters for one or more said process modules control are distributed to each said module via one or more of said control panels.

Other features and advantages of the present invention will become apparent upon examining the following detailed description of an embodiment thereof, taken in conjunction with the attached drawings.

### BRIEF DESCRIPTION OF THE DRAWINGS

These, as well as other aspects, features, and advantages of the present invention will become apparent upon reference to the following drawings in conjunction with more detailed description to be followed, wherein:

FIG. 1 is an exemplary schematic diagram depicting a typical sensor and actuator arrangement in a PED module, according to an illustrative embodiment of the invention.

FIG. 2 is an exemplary schematic representation showing how sensors and actuators in a plurality of PED modules are interconnected to a central control panel within a water treatment site, according to an illustrative embodiment of the invention. Note: PED* denotes PED with utilizing Spectrometer and/or Sensors for such: Temperature; Pressure; Humidity; TDS; pH; Conductivity; TOC (Total Organic Carbon); ORP (Oxygen Reduction Poetential); Chlorine; Chemical Contaminants; . . .

FIG. 3 is an exemplary schematic block diagram depicting the way a plurality of water treatment sites communicate with a operation control center, according to an illustrative embodiment of the invention.

FIG. 4 is an exemplary flow chart of an MCU based automatic control of a PED module, according to an illustrative embodiment of the invention.

FIG. 5 is an exemplary flow chart of a site management in accordance with one aspect of the present invention, according to an illustrative embodiment of the invention.

FIG. 6 is an exemplary flow chart of an operation control management in accordance with one aspect of the present invention, according to an illustrative embodiment of the invention.

FIG. 7 is an exemplary schematic diagram depicting a typical multi processing module communication means link to a cloud database and web app operation center, according to an illustrative embodiment of the invention.

FIG. 8 illustrates an exemplary schematic diagram depicting a typical sensor and actuator arrangement in a processing module, according to an illustrative embodiment of the invention.

The above-described and other features will be appreciated and understood by those skilled in the art from the following detailed description, drawings, and appended claims.

### DETAILED DESCRIPTION OF THE PREFERRED EMBODIMENT

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

Simplifications or omissions may be made to avoid obscuring the purpose of the section. Such simplifications or omissions are not intended to limit the scope of the present invention. All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

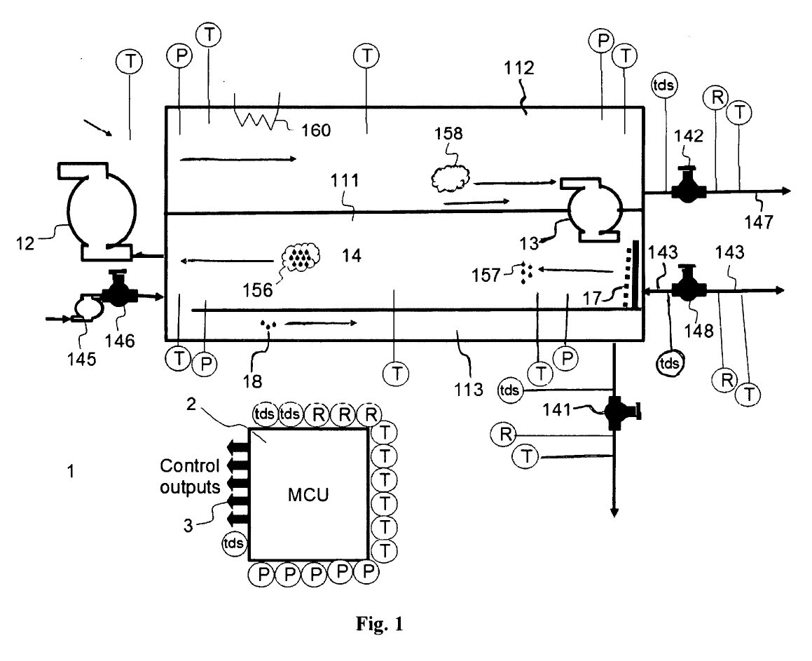

Referring to FIG. 1, there is shown a schematic diagram depicting a typical sensor and actuator arrangement in a PED module 1 in accordance with one aspect of the present invention. The PED module comprises a plurality of evaporation cavities 111, of which only one is shown, a plurality of condensation cavities 112, of which only one is shown, a larger throughput compressor 12, a smaller throughput compressor 13, a digitally controlled valve (DCV) 142 controlling a product water outlet 147, a DCV 148 controlling a source water inlet 143 which also doubles as a back wash effluent outlet (hence the bidirectional arrow), a high pressure water back wash pump 145 and a back wash DCV 146. The set of DCV valves and compressors/pump, micro-bubble-generator/mister 17 as well as the starter/stabilizer heating coil 160 are considered as the set of actuators, and there are temperature sensors (denoted by T), pressure sensors (denoted by P), flow sensors (denoted by R for flow Rate), and TDS sensors (denoted by tds) which measure the water/air temperatures, pressures, total dissolved solid concentrations (TDS), and flow rates in and out of the various inlets/outlets and brine outlet.

The PED module has a closed internal air loop actuated by the two compressors 12 and 13 which together form a compander (compressor-expander) arrangement. Owing to the larger volume of gas 12 can push through, and the relatively smaller volume of gas 13 can deliver, the gas pressure in the condenser 111 will be less than that of the evaporator 112. The input source water through 143 is mixed with the compressed air coming from the micro-bubble generator/mister 17 to generate a fine mist of droplets 157 directed at the common heat exchange wall 14. The droplets are heated by the heat exchanger through the wall 14 to generate a saturated vapor 156 which is drawn into the inlet of the compressor 12 which is then compressed and sent forward to the proximal (relative to 12) end of the condenser 112. As the compressed air is now supersaturated, condensation takes place until the excess vapor is removed. As the saturated air travels further downstream, the condensation continue to take place as the air is adjusting to lower and lower saturated pressure, until the air is almost fully depleted of the moisture 158. The relatively dry air 158 is recompressed by 13 to power the micro-bubble generator. The lower pressure in the evaporator cavity 111 also helps to cause the input mist to flash into vapor. The portion of the water 18 within the evaporator cavity 111 that is not evaporated at the end of the evaporation path is reflowed toward the distal end through a narrow counter-flow heat exchange tunnel 113 to preheat the source water. The brine DCV 141 is opened whenever the measured TDS from the TDS sensor before 141 exceeds a threshold value, and it is closed when the measured TDS level drops below a lower threshold value.

The set points of the TDS thresholds for 141 is determined by the electronic control means, which may be comprised in one embodiment of a micro-controller (MCU) 2 which also receives signals from all the temperature, pressure, and TDS sensors and determines what actions to take an sends control signals to corresponding actuators via controller outputs 3. The inflow and outflow rates from the flow meters are integrated by 2 to determine if a partial or total blockage had occurred, or when there is a strong possibility of a leak, or if the current TDS measurements greatly exceed the moving-averaged TDS values by a large threshold. When some or all of these conditions occurred, there is a strong indication that said PED module should receive accelerated maintenance schedule such as shortening the intervals between back washing, or that the PED cartridge needs replacement, or the entire PED unit should be taken offline and replaced.

The MCU is also responsible for using the collected sensor data as well as historical data for past sensor data and actions taken to estimate the counter-flow heat exchange LMTD to compute the expected entropy production rate. This could be used to perform local optimization of the PED module subjected to the constraint set forth by the site control panel.

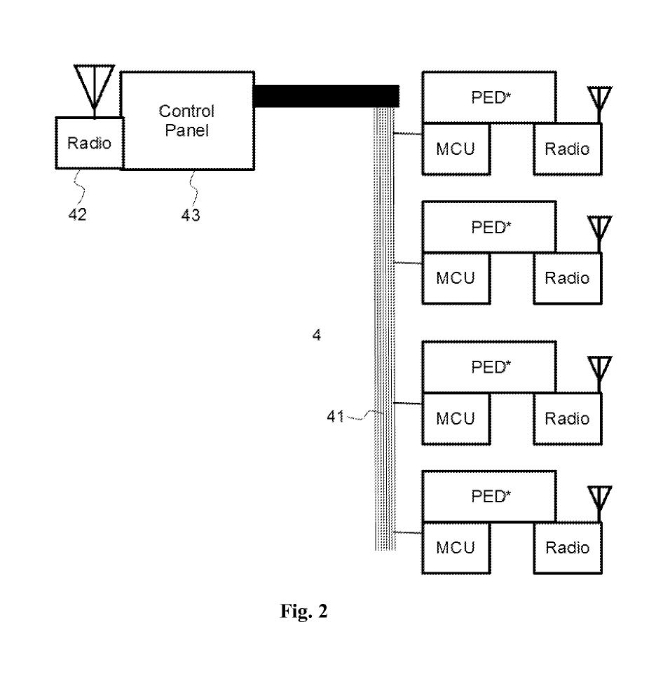

FIG. 2 is a schematic representation showing how sensors and actuators in a plurality of PED modules are interconnected to a central control panel within a water treatment site 4. The sensor and actuator signals are processed by the embedded micro-controller 2 of each PED module and selectively send to the central control panel 43 via a shared data communications mean. Such data communications mean could be a control (and power) bus 42, or optionally, a radio data communication network with a radio unit 43 on each PED module communicating with said MCU 2.

The radio unit could employ any wireless data communications mean, such as Zigbee, Bluetooth, IEEE 802.11n/ac, or cellular radio (2G, 3G, 4G) if the area of coverage exceeds the range that could be provided by aforementioned shorter range wireless technologies. It is vital that the data communication network employed is secure and private to prevent hacking as any hijacked network could be used to take over the control of the water treatment facility with predictably dire consequence.

While each MCU attached to a PED module is able to perform model predictive computations based on processed sensor input data to estimate net entropy production rate and utilize the resulting model to determine optimal actions to be taken to improve energy and operational efficiencies, such local control strategy is not necessarily optimal for the water treatment site in question. By communicating individual PED status or telemetry data to the control panel, it permits the control panel to provide additional optimization tasks such as load balancing to improve site energy efficiency and operational/maintenance costs and buffering of pre-processed water to relieve peak hour demands. The central control panel also can provide site statistics to individual PED modules to assist said PED to modify the predictive model accordingly to improve its prediction accuracy.

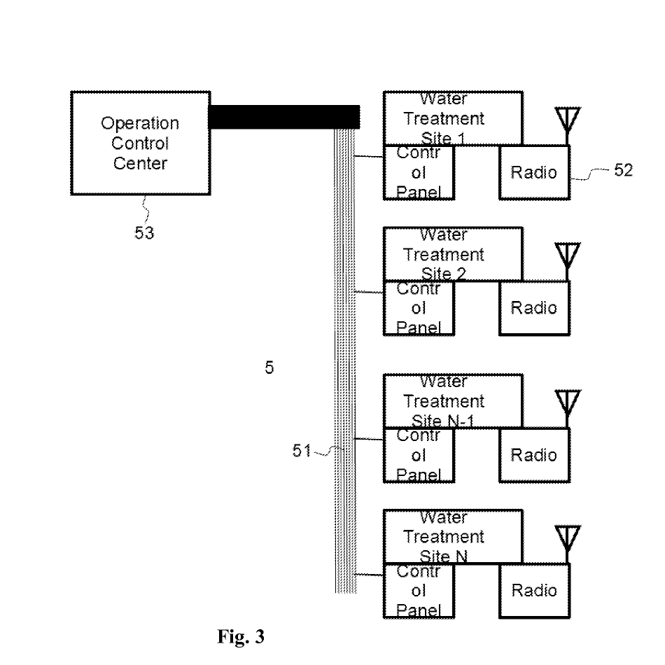

FIG. 3 is a schematic block diagram depicting the way a plurality of water treatment sites 4 communicate with a operation control center 53. The information each PED control panel collected is analyzed and selectively forwarded to the operation control center 53 via a private data communications network 51, or they could also be transmitted via a radio link with radio unit 52 connected to the control panel of each module.

The main task of the operation control center is to perform large scale load balancing taking into account the water supplies and demands of each site, and its respective water treatment capacity. Its secondary task is to provide a human friendly user interface, preferably a graphical user interface, to allow wide area monitoring of all the water treatment sites. Thirdly, the operation control center posts processed site data into a database which can be accessed by any authorized user via a secured channel. The information accessible by users includes general account information, site-wide operation status, maintenance records, alarm history, service contract status, financial balance sheets, and regulatory compliance records.

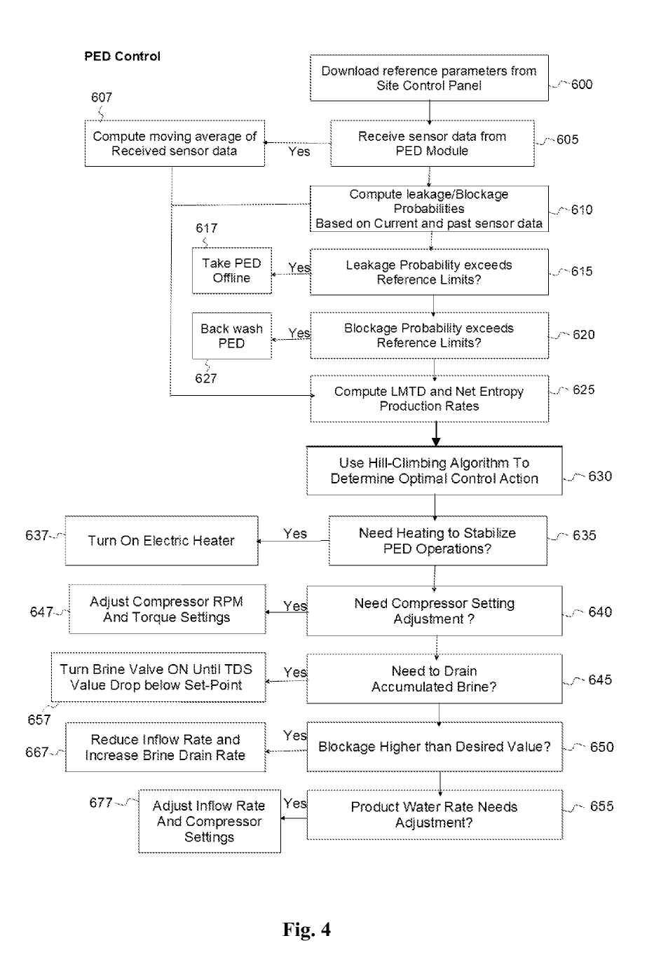

FIG. 4 is a flow chart of a MCU based automatic control of a PED module. In this preferred approach, the MCU of the PED module downloads reference parameters from site control panel 600, and receives sensors data from the array of sensors 605, and computes moving averages of sensor data 607. Using moving average data and estimated internal entropy production rate data, a model based computation is carried out to estimate leakage/blockage probabilities 610. If the leakage probability exceeds a confidence level threshold which is based on said reference parameters received 615, the PED module in question is taken offline and alarm is sent to site control panel 617. If, on the other hand, the blockage probability exceeds a confidence level threshold which is based on said reference parameters received 620, the PED module in question is marked for immediate back wash operation to unclog the PED cartridge 627, or in case the cartridge is deemed unusable, the cartridge is marked for replacement at the next maintenance cycle. Otherwise the LMTD data for all heat exchange surfaces are computed and net entropy production rates are estimated accordingly 625. The computed data is fed to a hill climbing algorithm, which could be a simple gradient descent algorithm, or a Newton or quasi-Newton quadratic search algorithm, or their equivalents, to determine the optimal control actions to be taken 630.

If the action as determined by said algorithm is to introduce direct heat to stabilize the PED operation 635, then an electric heater is turned on to increase the maximum temperature within the evaporator cavities 637. If there is either inadequate compression, too much compression, or the gas flow rate is not in normal range 640, then the compressor RPM speeds or the torque value are adjusted 547. If the accumulated brine concentration estimated based on measured TDS value and brine temperature is higher than the respective reference parameters 645, then the brine valve opens to drain the accumulated brine until the TDS value drops to normal range 657. If the estimated blockage rate exceeds the reference rate 650, then the inflow rate is reduced and the brine concentration is lowered by increasing the frequency at which the brine is drained 667. Finally, if the demand for product water is reduced 655, then the inflow rate and compressor settings are adjusted accordingly to satisfy the demand as well as the load balancing action 677.

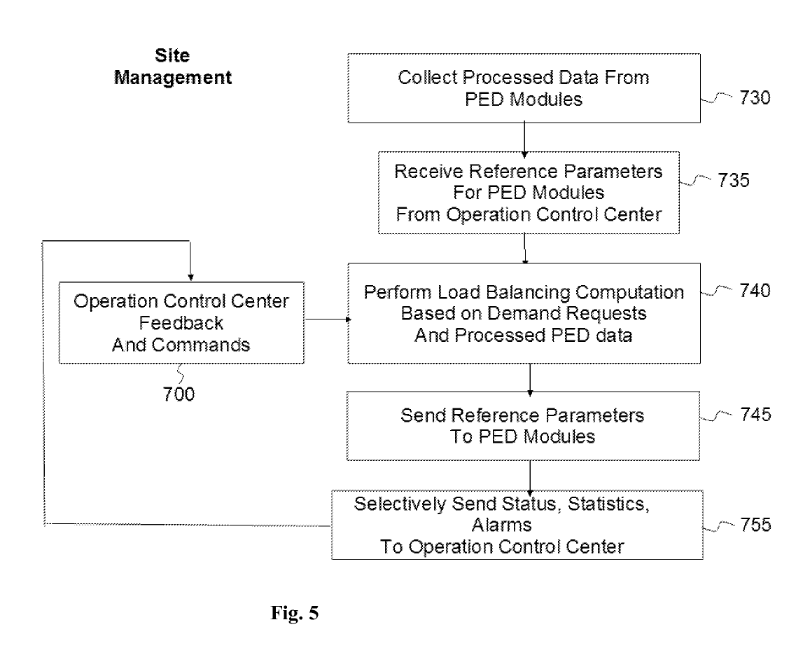

FIG. 5 is a flow chart of a site management in accordance with one aspect of the present invention. In this approach, the site control panel collects processed data from individual PED modules 730, and receives reference parameters for site PED modules from operation control center 735. These information are employed to perform load balancing computation based on supply/demand requests from operation control center 700 and processed PED data 740. The reference parameters are delivered to PED modules 745, and selected data including status information about each PED module, general statistics, and alarms, to operation control center 755.

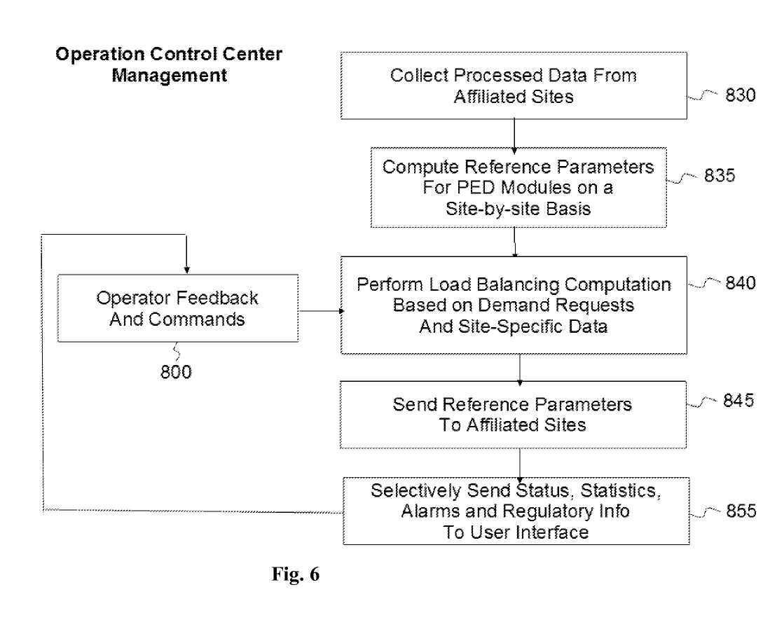

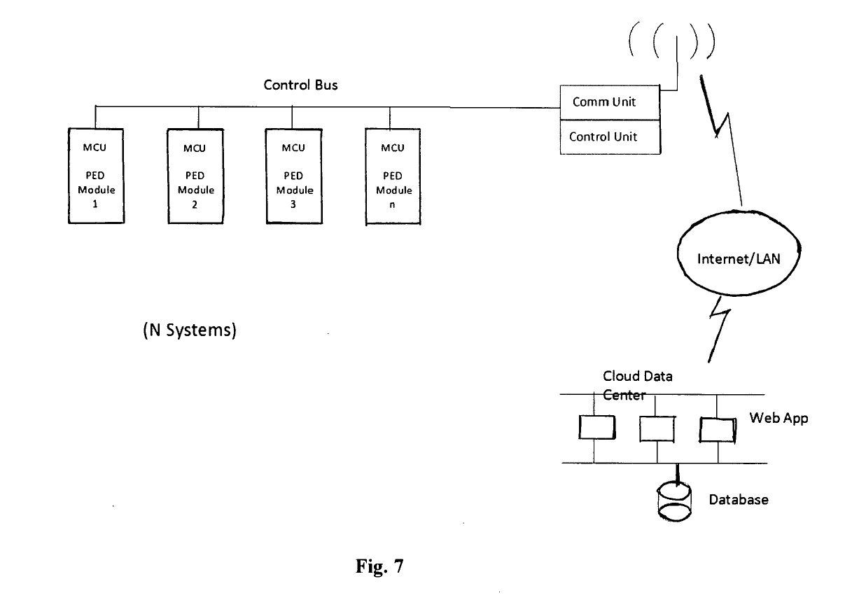

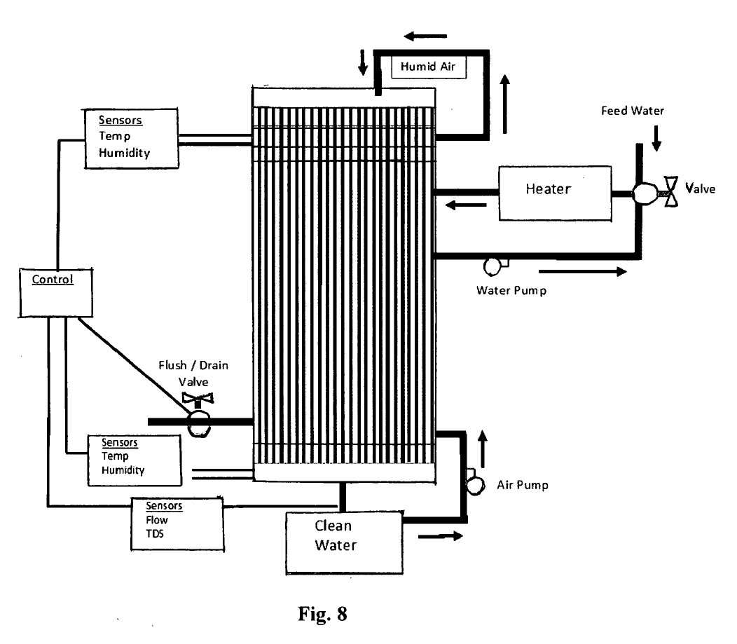

FIGS. 6-8 show a flow chart of an operation control management in accordance with one aspect of the present invention, and sends forward site specific reference parameters to affiliated sites 845. In this, the operation control center collects processed data from affiliated water treatment sites 830. Together with operator feedback and commands 800, a load balancing computation is computed taking into consideration site specific data available 840. The generated reference parameters are sent to affiliated sites 845, Selected status, statistics, alarms, and regulatory information are displayed on a user interface, preferably graphic user interface 855, to allow center operators to monitor the activities and status of affiliated sites and make changes by overriding computer generated parameters or automatically generated requests 800.

Those with ordinary skill in the art should appreciate that the parameters and structures described herein are merely exemplary and that actual parameters or constructs will depend on specific applications in which the systems and methods are used. It will also be appreciated that, using no more than routine experimentation, that embodiments described herein are presented by way of examples only and that, within the scope of the appended claims, and equivalents thereto, the invention may be practiced otherwise than as specifically described.

The system/process for collecting and gathering data described in this patent application/document can also be used to gather the same or similar data from any other liquid/fluid purification or filtering system, not just a PED system.

### CONCLUSION

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

1. A fluid treatment system comprising;
a plurality of fluid treatment processing modules located within a site, wherein each said processing module is comprised of at least one from the list of; sensors and/or transducers, electronic control means and/or data communications means;
wherein each said module may receive sensor signals from each said sensor so as to have said module's electronic control means form and/or execute a model predictive decision process wherewith to determine action to be taken through one or more of each said transducers for the purpose of maximizing operational efficiency within each said module and when necessary use, and said data communications means transmits processed module status data to one or more site control panels;
one or more site control panels overseeing one or more processing modules within a site, wherein each said site control panel is in communication with one or more said fluid treatment modules in order to communicate status information to/from one or more said modules, collect, process, analyze and/or update information about said one or more panels, communicate to/from one or more operational control center(s) and update individual processing module(s) reference parameters through said communication means;
one or more operational control center(s) in communications with said one or more site control panels in order to communicate site specific reference parameters and/or status updates to/from said one or more site control panels, wherein said one or more operation control center(s) utilize site control strategy means to analyze, generate and periodically update individual processing module specific parameters based on site parameters that are common to a plurality of processing modules, so that based on desired optimal individual module response, individual parameters for one or more said process modules control are distributed to each said module via one or more of said control panels.

2. the system of claim 1 wherein;
said site control strategy means include site/individual module data/status attributes comprised of at least one of:
site fluid demands, site safety parameters, site source fluid status, site logarithmic mean temperature difference, module flow rates, module status, module schedule maintenance and/or module deviation from normal parameters; and
said data communications means may be comprised of at least one of:
wired or wireless links, encrypted radio links, secured private network connection, Wi-Fi (including but not limited to IEEE802.11n, 802.11ac and similar variations), ZigBee, Bluetooth, Cellular radio (including but not limited to 3G, 4G, LTE and similar variations);

3. the system of claim 2 wherein;
selected process information from one or more said process modules from one or more sites is presented through a user interface to a human so that they may be adjusted through human assisted actions.

4. the system of claim 3 wherein;
said information presented to said human is comprised of at least one of:
general account information, site-wide operation status, maintenance records, alarm history, service contract status, financial balance sheets, and/or regulatory compliance records.

5. the system of claim 4 wherein;
said fluid control modules are Pulse Effect Distillation™ (PED) modules.

6. the system of claim 5 wherein;
said one or more operational control center(s) and said one or more site control panel(s) are located in a private secure cloud.

7. the system of claim 5 wherein;
said one or more operational control center(s) and said one or more site control panel(s) are located in a virtual private network tunnel to a web based cloud.

8. the system of claim 2 wherein;
said fluid control modules are Pulse Effect Distillation™ (PED) modules.

9. the system of claim 8 wherein;
said one or more operational control center(s) and said one or more site control panel(s) are located in a private secure cloud.

10. the system of claim 8 wherein;
said one or more operational control center(s) and said one or more site control panel(s) are located in a virtual private network tunnel to a web based cloud.

11. A fluid treatment method comprising;
providing a plurality of fluid treatment processing modules located within a site, wherein each said processing module is comprised of at least one from the list of;
sensors and/or transducers, electronic control means and/or data communications means;
wherein each said module may receive sensor signals from each said sensor so as to have said module's electronic control means form and/or execute a model predictive decision process wherewith to determine action to be taken through one or more of each said transducers for the purpose of maximizing operational efficiency within each said module and when necessary use, and said data communications means transmits processed module status data to one or more site control panels;
providing one or more site control panels overseeing one or more processing modules within a site, wherein each said site control panel is in communication with one or more said fluid treatment modules in order to communicate status information to/from one or more said modules, collect, process, analyze and/or update information about said one or more panels, communicate to/from one or more operational control center(s) and update individual processing module(s) reference parameters through said communication means;
providing one or more operational control center(s) in communications with said one or more site control panels in order to communicate site specific reference parameters and/or status updates to/from said one or more site control panels, wherein said one or more operation control center(s) utilize site control strategy means to analyze, generate and periodically update individual processing module specific parameters based on site parameters that are common to a plurality of processing modules, so that based on desired optimal individual module response, individual parameters for one or more said process modules control are distributed to each said module via one or more of said control panels.

12. the method of claim 11 wherein;
said site control strategy means include site/individual module data/status attributes comprised of at least one of:
site fluid demands, site safety parameters, site source fluid status, site logarithmic mean temperature difference, module flow rates, module status, module schedule maintenance and/or module deviation from normal parameters; and
said data communications means may be comprised of at least one of:
wired or wireless links, encrypted radio links, secured private network connection, Wi-Fi (including but not limited to IEEE802.11n, 802.11ac and similar variations), ZigBee, Bluetooth, Cellular radio (including but not limited to 3G, 4G, LTE and similar variations);

13. the method of claim 12 wherein;
selected process information from one or more said process modules from one or more sites is presented through a user interface to a human so that they may be adjusted through human assisted actions.

14. the method of claim 13 wherein;
said information presented to said human is comprised of at least one of:
general account information, site-wide operation status, maintenance records, alarm history, service contract status, financial balance sheets, and/or regulatory compliance records.

15. the method of claim 14 wherein;
said fluid control modules are Pulse Effect Distillation™ (PED) modules.

16. the method of claim 15 wherein;
said one or more operational control center(s) and said one or more site control panel(s) are located in a private secure cloud.

17. the method of claim 15 wherein;
said one or more operational control center(s) and said one or more site control panel(s) are located in a virtual private network tunnel to a web based cloud.

18. the method of claim 12 wherein;
said fluid control modules are Pulse Effect Distillation™ (PED) modules.

19. the method of claim 18 wherein;
said one or more operational control center(s) and said one or more site control panel(s) are located in a private secure cloud.

20. the method of claim 18 wherein;
said one or more operational control center(s) and said one or more site control panel(s) are located in a virtual private network tunnel to a web based cloud.
